(19) United States
(12) Patent Application Publication
(10) Pub. No.: US 2022/0145034 A1
(43) Pub. Date: May 12, 2022

(54) METHOD FOR PRODUCING A COPOLYMER FOAM WITH POLYAMIDE BLOCKS AND POLYETHER BLOCKS

(71) Applicant: Arkema France, Colombes (FR)

(72) Inventor: Clio COCQUET, Serquigny (FR)

(73) Assignee: Arkema France, Colombes (FR)

(21) Appl. No.: 17/439,107

(22) PCT Filed: Mar. 16, 2020
(86) PCT No.: PCT/FR2020/050546

§ 371 Date: Sep. 14, 2021

(30) Foreign Application Priority Data
Mar. 15, 2019 (FR) 1902702

(51) Int. Cl. C08J 9/12; B29C 44/42

(52) U.S. Cl. CPC C08J 9/122; B29C 44/42; C08J 2203/06; B29K 2105/0085; C08J 2371/02; C08J 2377/00; C08J 2203/182

(57) ABSTRACT

A process for producing a copolymer foam containing polyamide blocks and polyether blocks, including the following steps: mixing the copolymer in the melt state with a blowing agent; foaming of the mixture of copolymer and blowing agent, wherein the blowing agent includes a mixture of dinitrogen and carbon dioxide. Also, a copolymer foam containing polyamide blocks and polyether blocks which can be obtained by such a production process.

### FIELD OF THE INVENTION

The present invention relates to a process for producing a copolymer foam containing polyamide blocks and polyether blocks.

### TECHNICAL BACKGROUND

Various polymer foams are used notably in the field of sports equipment, such as soles or sole components, gloves, rackets or golf balls, personal protection items in particular for practicing sports (jackets, interior parts of helmets, shells, etc.). For example, copolymer foams containing polyamide blocks and polyether blocks (or PEBA foams) are particularly suitable for these applications.

Such applications require a set of particular physical properties which ensure rebound capacity, a low compression set and a capacity for enduring repeated impacts without becoming deformed and for returning to the initial shape.

Document FR 3047245 describes PEBA foams obtained by an injection molding process with dinitrogen as foaming agent. Such foams can have a relatively low density. However, for some applications it may be desirable to obtain foams of even lower densities.

Documents EP 0405227 and EP 0402883 describe foams produced from various polymers and the use thereof in shoe soles.

Document EP 1650255 describes crosslinked foams obtained from copolymers containing polyamide blocks and polyether blocks.

Crosslinked foams have the drawback of having high constraints from the point of view of the production process: the production time is generally long, the production is generally necessary in batch mode only, and undesirable chemical products must be handled.

In addition, crosslinked foams are difficult to recycle after use.

Document WO 2013/148841 describes a process of two-layer extrusion using various polymers, including copolymers containing polyamide blocks and polyether blocks.

Document WO 2015/052265 describes a process for producing expanded thermoplastic particles using any elastomeric thermoplastic polymer.

Document US 2015/0174808 describes a process for producing expanded polymer pellets, in particular polyurethane pellets.

Kin Lin's thesis, Development of high strength microcellular foams using polyether block amide, 2010, Department of Mechanical & Industrial Engineering, University of Toronto, describes PEBA foams or PEBA mixture foams obtained in a batch process using carbon dioxide.

Document GB 2296014 relates to golf balls with a core of thermoplastic polymer foam, such as a polyamide or a polyether polyamide copolymer.

Document US 2005/0049545 describes a process for producing a medical device wherein a second polymeric material is overmolded on a first polymeric material, the second polymeric material being converted into a foam.

Document JP 2005350574 describes foams of thermoplastic polymers produced using an inert gas (carbon dioxide or dinitrogen).

Moreover, the company Zotefoams markets crosslinked foams produced from copolymers containing polyamide blocks and polyether blocks, under the name Zotek® PEBA. The drawbacks of crosslinking have been recalled above. Furthermore, the durability of the products is not ideal.

Dinitrogen or carbon dioxide are conventionally used during the production of polymer foams, in particular in injection molding processes. However, in the case of PEBA foams, these blowing agents have certain drawbacks.

There is a real need to provide a process for producing a copolymer foam containing polyamide blocks and polyether blocks making it possible to obtain a very low density foam of good quality which is also recyclable.

### SUMMARY OF THE INVENTION

The invention relates firstly to a process for producing a copolymer foam containing polyamide blocks and polyether blocks, comprising the following steps:
mixing the copolymer in the melt state with a blowing agent;
foaming of the mixture of copolymer and blowing agent;
   wherein the blowing agent comprises a mixture of dinitrogen and carbon dioxide.

According to embodiments, the invention relates to a process for producing a copolymer foam containing polyamide blocks and polyether blocks, comprising the following steps:
mixing the copolymer in the melt state with a blowing agent;
foaming of the mixture of copolymer and blowing agent;
   wherein the blowing agent comprises a mixture of dinitrogen and carbon dioxide, said process being an injection molding process.

According to embodiments, the blowing agent comprises from 20% to 95% by weight, preferably from 40% to 95% by weight, of dinitrogen, and from 5% to 80% by weight, preferably from 5% to 60% by weight, of carbon dioxide.

According to embodiments, the polyamide blocks of the copolymer have a number-average molar mass of from 400 to 20 000 g/mol, preferably from 500 to 10 000 g/mol.

According to embodiments, the polyether blocks of the copolymer have a number-average molar mass of from 100 to 6000 g/mol, preferably from 200 to 3000 g/mol.

According to embodiments, the mass ratio of the polyamide blocks relative to the polyether blocks of the copolymer is from 0.1 to 20, preferably from 0.3 to 3, even more preferentially from 0.3 to 0.9.

According to embodiments, the polyamide blocks of the copolymer are blocks of polyamide 6, of polyamide 11, of polyamide 12, of polyamide 5.4, of polyamide 5.9, of polyamide 5.10, of polyamide 5.12, of polyamide 5.13, of polyamide 5.14, of polyamide 5.16, of polyamide 5.18, of polyamide 5.36, of polyamide 6.4, of polyamide 6.9, of polyamide 6.10, of polyamide 6.12, of polyamide 6.13, of polyamide 6.14, of polyamide 6.16, of polyamide 6.18, of polyamide 6.36, of polyamide 10.4, of polyamide 10.9, of polyamide 10.10, of polyamide 10.12, of polyamide 10.13, of polyamide 10.14, of polyamide 10.16, of polyamide 10.18, of polyamide 10.36, of polyamide 10.T, of polyamide 12.4, of polyamide 12.9, of polyamide 12.10, of polyamide 12.12, of polyamide 12.13, of polyamide 12.14, of polyamide 12.16, of polyamide 12.18, of polyamide 12.36, of polyamide 12.T or mixtures thereof, or copolymers thereof, preferably of polyamide 11, of polyamide 12, of polyamide 6 or of polyamide 6.10.

According to embodiments, the polyether blocks are blocks of polyethylene glycol, of propylene glycol, of polytrimethylene glycol, of polytetrahydrofuran, or mixtures or copolymers thereof, preferably are blocks of polyethylene glycol or of polytetrahydrofuran.

According to embodiments, the foam has a density less than or equal to 0.8 g/cm³, preferably a density of from 0.05 to 0.8 g/cm³, more preferentially from 0.08 to 0.5 g/cm³, even more preferentially from 0.08 to 0.3 g/cm³.

According to embodiments, the foam is noncrosslinked.

According to embodiments, the process comprises a step of injecting the mixture of copolymer and blowing agent into a mold, the foaming of the mixture being carried out by opening the mold.

According to embodiments, the blowing agent is present in the mixture of copolymer and blowing agent in a mass amount of from 0.1% to 10%, preferably from 0.2% to 5%, even more preferentially from 0.2% to 1.5%, relative to the sum of the weights of the blowing agent and of the copolymer containing polyamide blocks and polyether blocks.

According to embodiments, the process comprises mixing the copolymer in the melt state with a blowing agent and with one or more additives, preferably chosen from copolymers of ethylene and of vinyl acetate, copolymers of ethylene and of acrylate, and copolymers of ethylene and of alkyl (meth)acrylate.

The invention also relates to a copolymer foam containing polyamide blocks and polyether blocks which can be obtained by a production process as described above.

According to embodiments, the foam has a density less than or equal to 0.8 g/cm³, preferably a density of from 0.05 to 0.8 g/cm³, more preferentially from 0.08 to 0.5 g/cm³, even more preferentially from 0.08 to 0.3 g/cm³.

According to embodiments, the foam has an expansion rate ranging from 2 to 25, preferably from 3 to 20, more preferentially from 4 to 15.

The present invention meets the need expressed above. It more particularly provides a process for producing a copolymer foam containing polyamide blocks and polyether blocks making it possible to obtain foams which simultaneously are recyclable, of low or even very low density and have good mechanical properties such as good strength.

This is accomplished through the use of a particular blowing agent to generate the foaming of the copolymer, comprising a mixture of dinitrogen and carbon dioxide.

Indeed, the use of dinitrogen or carbon dioxide alone for the production of PEBA foam has certain drawbacks.

Thus, dinitrogen gives rise to a weak expansion, which does not make it possible to achieve very low foam density values.

The use of carbon dioxide as a blowing agent leads to the creation of a vacuum inside the PEBA foam, due to the very rapid diffusion of carbon dioxide outside the foam. This causes the foam to collapse on itself, making it unusable.

### BRIEF DESCRIPTION OF THE FIGURES

FIG. 1 is an image obtained by scanning electron microscopy (SEM) of the alveolar structure of foam No. 1 obtained according to the process described in example 1 using a mixture of 75% by weight of dinitrogen and 25% by weight of carbon dioxide as blowing agent, introduced in an amount of 1% by weight.

FIG. 2 is an image obtained by SEM of the alveolar structure of foam No. 2 obtained according to the process described in example 1 using a mixture of 75% by weight of dinitrogen and 25% by weight of carbon dioxide as blowing agent, introduced in an amount of 1.2% by weight.

FIG. 3 is an image obtained by SEM of the alveolar structure of foam No. 3 obtained according to the process described in example 1 using dinitrogen as blowing agent, introduced in an amount of 0.6% by weight.

FIG. 4 is an image obtained by SEM of the alveolar structure of foam No. 4 obtained according to the process described in example 1 using dinitrogen as blowing agent, introduced in an amount of 0.8% by weight.

FIG. 5 is an image of foam No. 2 obtained according to the process described in example 1 using a mixture of 75% by weight of dinitrogen and 25% by weight of carbon dioxide as blowing agent, introduced in an amount of 1.2% by weight.

FIG. 6 is an image of foam No. 3 obtained according to the process described in example 1 using dinitrogen as blowing agent, introduced in an amount of 0.6% by weight.

FIG. 7 is an image of foam No. 5 obtained according to the process described in example 1 using carbon dioxide as blowing agent, introduced in an amount of 6-8% by weight.

### DETAILED DESCRIPTION

The invention is now described in greater detail and in a nonlimiting manner in the description that follows.

Unless otherwise indicated, all the percentages are mass percentages.

The invention relates to a process for producing a copolymer foam containing polyamide blocks and polyether blocks (or PEBA).

PEBAs result from the polycondensation of polyamide blocks bearing reactive ends with polyether blocks bearing reactive ends, such as, inter alia, the polycondensation:

1) of polyamide blocks bearing diamine chain ends with polyoxyalkylene blocks bearing dicarboxylic chain ends;

2) of polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks, known as polyetherdiols;

3) of polyamide blocks bearing dicarboxylic chain ends with polyetherdiols, the products obtained being, in this particular case, polyetheresteramides.

The polyamide blocks bearing dicarboxylic chain ends originate, for example, from the condensation of polyamide precursors in the presence of a chain-limiting dicarboxylic acid. The polyamide blocks bearing diamine chain ends originate, for example, from the condensation of polyamide precursors in the presence of a chain-limiting diamine.

Three types of polyamide blocks may advantageously be used.

According to a first type, the polyamide blocks originate from the condensation of a dicarboxylic acid, in particular those containing from 4 to 20 carbon atoms, preferably those containing from 6 to 18 carbon atoms, and of an aliphatic or aromatic diamine, in particular those containing from 2 to 20 carbon atoms, preferably those containing from 6 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids. As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 4.12, PA 4.14, PA 4.18, PA 6.10, PA 6.12, PA 6.14, PA 6.18, PA 9.12, PA 10.10, PA 10.12, PA 10.14 and PA 10.18 are used. In the notation PA X.Y, X represents the number of carbon atoms derived from the diamine residues and Y represents the number of carbon atoms derived from the diacid residues, as is conventional.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 12 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 11-aminoundecanoic acid and 12-aminododecanoic acid.

Advantageously, the polyamide blocks of the second type are PA 11 (polyundecanamide), PA 12 (polydodecanamide) or PA 6 (polycaprolactam) blocks. In the notation PA X, X represents the number of carbon atoms derived from amino acid residues.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y);
said comonomer(s) {Z} being introduced in a weight proportion advantageously ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or from at least two lactams containing from 6 to 12 carbon atoms or from one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 98%; they are preferably hydrogenated; they are, for example, products sold under the brand name Pripol by Croda, or under the brand name Empol by BASF, or under the brand name Radiacid by Oleon, and polyoxyalkylene α,ω-diacids. As examples of aromatic diacids, mention may be made of terephthalic acid (T) and isophthalic acid (I). As examples of cycloaliphatic diamines, mention may be made of the isomers bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 6.6/6, wherein 6.6 denotes hexamethylenediamine units condensed with adipic acid and 6 denotes units resulting from the condensation of caprolactam;
PA 6.6/6.10/11/12, wherein 6.6 denotes hexamethylenediamine condensed with adipic acid, 6.10 denotes hexamethylenediamine condensed with sebacic acid, 11 denotes units resulting from the condensation of aminoundecanoic acid, and 12 denotes units resulting from the condensation of lauryllactam.

The notations PA X/Y, PA X/Y/Z, etc. relate to copolyamides wherein X, Y, Z, etc. represent homopolyamide units as described above.

Advantageously, the polyamide blocks of the copolymer used in the invention comprise polyamide PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36 or PA 12.T blocks, or mixtures or copolymers thereof; and preferably comprise polyamide PA 6, PA 11, PA 12, PA 6.10, PA 10.10 or PA 10.12 blocks, or mixtures or copolymers thereof.

The polyether blocks are formed from alkylene oxide units.

The polyether blocks may notably be PEG (polyethylene glycol) blocks, i.e. blocks formed from ethylene oxide units, and/or PPG (propylene glycol) blocks, i.e. blocks formed from propylene oxide units, and/or PO3G (polytrimethylene glycol) blocks, i.e. blocks formed from polytrimethylene glycol ether units, and/or PTMG blocks, i.e. blocks formed from tetramethylene glycol units, also known as polytetrahydrofuran. The PEBA copolymers may comprise in their chain several types of polyethers, the copolyethers possibly being in block or statistical form.

Use may also be made of blocks obtained by oxyethylation of bisphenols, for instance bisphenol A. The latter products are notably described in document EP 613 919.

The polyether blocks may also be formed from ethoxylated primary amines. As examples of ethoxylated primary amines, mention may be made of the products of formula:

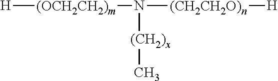

wherein m and n are integers between 1 and 20, and x is an integer between 8 and 18. These products are commercially available for example under the brand name Noramox® from CECA and under the brand name Genamin® from Clariant.

The flexible polyether blocks may comprise polyoxyalkylene blocks bearing NH₂ chain ends, such blocks being able to be obtained by cyanoacetylation of α,ω-dihydroxylated aliphatic polyoxyalkylene blocks referred to as polyetherdiols. More particularly, the commercial products Jeffamine or Elastamine may be used (for example Jeffamine® D400, D2000, ED 2003, XTJ 542, which are commercial products from Huntsman, also described in documents JP 2004/346274, JP 2004/352794 and EP 1482011).

The polyetherdiol blocks are either used in unmodified form and copolycondensed with polyamide blocks bearing carboxylic end groups, or are aminated to be converted into polyetherdiamines and condensed with polyamide blocks bearing carboxylic end groups. The general method for the two-step preparation of PEBA copolymers containing ester bonds between the PA blocks and the PE blocks is known and is described, for example, in document FR 2846332. The general method for the preparation of the PEBA copolymers having amide bonds between the PA blocks and the PE blocks is known and is described, for example, in document EP 1482011. The polyether blocks may also be mixed with polyamide precursors and a chain-limiting diacid to prepare polymers containing polyamide blocks and polyether blocks having randomly distributed units (one-step process).

Needless to say, the name PEBA in the present description of the invention relates not only to the Pebax® products sold by Arkema, to the Vestamid® products sold by Evonik® and to the Grilamid® products sold by EMS, but also to the Pelestat® type PEBA products sold by Sanyo or to any other PEBA from other suppliers.

If the block copolymers described above generally comprise at least one polyamide block and at least one polyether block, the present invention also covers all the copolymer alloys comprising two, three, four (or even more) different blocks chosen from those described in the present description, provided that these blocks include at least polyamide and polyether blocks.

For example, the copolymer alloy according to the invention may comprise a segmented block copolymer comprising three different types of blocks (or “triblock” copolymer), which results from the condensation of several of the blocks described above. Said triblock copolymer is preferably chosen from copolyetherester amides and copolyether amide urethanes.

PEBA copolymers that are particularly preferred in the context of the invention are copolymers including blocks from among:
PA 11 and PEG;
PA 11 and PTMG;
PA 12 and PEG;
PA 12 and PTMG;
PA 6.10 and PEG;
PA 6.10 and PTMG;
PA 6 and PEG;
PA 6 and PTMG.

The number-average molar mass of the polyamide blocks in the PEBA copolymer is preferably from 400 to 20 000 g/mol, more preferentially from 500 to 10 000 g/mol. In certain embodiments, the number-average molar mass of the polyamide blocks in the PEBA copolymer is from 400 to 500 g/mol, or 500 to 600 g/mol, or from 600 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

The number-average molar mass of the polyether blocks is preferably from 100 to 6000 g/mol, more preferentially from 200 to 3000 g/mol. In certain embodiments, the number-average molar mass of the polyether blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol.

The number-average molar mass is set by the content of chain limiter. It may be calculated according to the equation:

Mₙ=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain limiter} represents the number of moles of diacid limiter in excess, MW_{repeating unit} represents the molar mass of the repeating unit, and MW_{chain limiter} represents the molar mass of the diacid in excess.

The number-average molar mass of the polyamide blocks and of the polyether blocks can be measured before the copolymerization of the blocks by gel permeation chromatography (GPC) according to the ISO standard 16014-1: 2012.

Advantageously, the mass ratio of the polyamide blocks relative to the polyether blocks of the copolymer is from 0.1 to 20, preferably from 0.3 to 3, even more preferentially from 0.3 to 0.9. This ratio by weight can be calculated by dividing the number-average molar mass of the polyamide blocks by the number-average molar mass of the polyether blocks. In particular, the mass ratio of the polyamide blocks relative to the polyether blocks of the copolymer may be from 0.1 to 0.2, or from 0.2 to 0.3, or from 0.3 to 0.4, or from 0.4 to 0.5, or from 0.5 to 0.6, or from 0.6 to 0.7, or from 0.7 to 0.8, or from 0.8 to 0.9, or from 0.9 to 1, or from 1 to 1.5, or from 1.5 to 2, or from 2 to 2.5, or from 2.5 to 3, or from 3 to 3.5, or from 3.5 to 4, or from 4 to 4.5, or from 4.5 to 5, or from 5 to 5.5, or from 5.5 to 6, or from 6 to 6.5, or from 6.5 to 7, or from 7 to 7.5, or from 7.5 to 8, or from 8 to 8.5, or from 8.5 to 9, or from 9 to 9.5, or from 9.5 to 10, or from 10 to 11, or from 11 to 12, or from 12 to 13, or from 13 to 14, or from 14 to 15, or from 15 to 16, or from 16 to 17, or from 17 to 18, or from 18 to 19, or from 19 to 20.

Preferably, the copolymer used in the invention has an instantaneous hardness of less than or equal to 40 Shore D, more preferably less than or equal to 35 Shore D. The hardness measurements may be performed according to the ISO standard 868:2003.

The copolymer containing polyamide blocks and polyether blocks is used for forming a foam, preferably without a crosslinking step. The foam is formed by mixing the copolymer in the melt state with a blowing agent (also called foaming agent), followed by performing a foaming step.

The blowing agent comprises a mixture of dinitrogen and carbon dioxide. Preferably, the blowing agent consists essentially of, or consists of, a mixture of dinitrogen and carbon dioxide.

Dinitrogen has a high nucleating capacity but a low expansive capacity. Carbon dioxide has a high expansive capacity but a low nucleating capacity. The combination of dinitrogen and carbon dioxide creates a synergy making it possible to obtain a blowing agent exhibiting both a high nucleating capacity and a high expansive capacity.

Advantageously, the blowing agent comprises, or consists essentially of, or consists of, from 20% to 95% by weight, preferably from 40% to 95% by weight, of dinitrogen, and from 5% to 80% by weight, preferably from 5% to 60% by weight, of carbon dioxide. In embodiments, the blowing agent comprises, consists essentially of, or consists of, from 1% to 5% by weight of dinitrogen and from 95% to 99% by weight of carbon dioxide, or from 5% to 10% by weight of dinitrogen and from 90% to 95% by weight of carbon dioxide, or from 10% to 15% by weight of dinitrogen and from 85% to 90% by weight of carbon dioxide, or from 15% to 20% by weight of dinitrogen and from 80% to 85% by weight of carbon dioxide, or from 20% to 25% by weight of dinitrogen and from 75% to 80% by weight of carbon dioxide, or from 25% to 30% by weight of dinitrogen and from 70% to 75% by weight of carbon dioxide, or from 30% to 35% by weight of dinitrogen and from 65% to 70% by weight of carbon dioxide, or from 35% to 40% by weight of dinitrogen and from 60% to 65% by weight of carbon dioxide, or from 40% to 45% by weight of dinitrogen and from 55% to 60% by weight of carbon dioxide, or from 45% to 50% by weight of dinitrogen and from 50% to 55% by weight of carbon dioxide, or from 50% to 55% by weight of dinitrogen and from 45% to 50% by weight of carbon dioxide, or from 55% to 60% by weight of dinitrogen and from 40% to 45% by weight of carbon dioxide, or from 60% to 65% by weight of dinitrogen and from 35% to 40% by weight of carbon dioxide, or from 65% to 70% by weight of dinitrogen and from 30% to 35% by weight of carbon dioxide, or from 70% to 75% by weight of dinitrogen and from 25% to 30% by weight of carbon dioxide, or from 75% to 80% by weight of dinitrogen and from 20% to 25% by weight of carbon dioxide, or from 80% to 85% by weight of dinitrogen and from 15% to 20% by weight of carbon dioxide, or from 85% to 90% by weight of dinitrogen and from 10% to 15% by weight of carbon dioxide, or from 90% to 95% by weight of dinitrogen and from 5% to 10% by weight of carbon dioxide, or from 95% to 99% by weight of dinitrogen and from 1% to 5% by weight of carbon dioxide.

The blowing agent is mixed with the copolymer in liquid or supercritical form and then converted into the gaseous phase during the foaming step.

The blowing agent is preferably present in the mixture in a mass amount of from 0.1% to 10%, preferably from 0.2% to 5%, even more preferentially from 0.2% to 1.5%, relative to the sum of the weights of the blowing agent and of the copolymer containing polyamide blocks and polyether blocks. Notably, the blowing agent may be present in a mass amount of from 0.1% to 0.2%, or from 0.2% to 0.4%, or from 0.4% to 0.6%, or from 0.6% to 0.8%, or from 0.8% to 1%, or from 1% to 1.5%, or from 1.5% to 2%, or from 2% to 2.5%, or from 2.5% to 3%, or from 3% to 3.5%, or from 3.5% to 4%, or from 4% to 4.5%, or from 4.5% to 5%, or from 5% to 6%, or from 6% to 7%, or from 7% to 8%, or from 8% to 9%, or from 9% to 10%, relative to the sum of the weights of the blowing agent and of the copolymer containing polyamide blocks and polyether blocks.

The foam obtained via the process according to the invention includes a PEBA copolymer as described above: preferably, only one such copolymer is used. It is, however, possible to use a mixture of two or more than two PEBA copolymers as described above.

The copolymer containing polyamide blocks and polyether blocks may be combined with various additives, for example copolymers of ethylene and vinyl acetate or EVA (for example those sold under the name Evatane® by Arkema), or copolymers of ethylene and of acrylate, or copolymers of ethylene and of alkyl (meth)acrylate, for example those sold under the name Lotryl® by Arkema. These additives may make it possible to adjust the hardness of the foamed part, its appearance and its comfort. The additives may be added in a content of from 0 to 50% by mass, preferentially from 5% to 30% by mass, relative to the copolymer containing polyamide blocks and polyether blocks.

The process for producing a foam according to the invention is preferably an injection molding process. This technique makes it possible directly to produce three-dimensional foamed objects with complex geometries. Preferably, the mixture of the copolymer and of the blowing agent is injected into a mold, and foaming takes place by opening the mold.

It is also a technique that is relatively simple to perform, notably in comparison with certain processes of melting foamed particles as described in the prior art: specifically, filling of the mold with foamed polymer granules followed by melting of the particles to ensure the mechanical strength of the parts without destroying the structure of the foam are difficult operations.

Other foaming techniques that can be used (but are less preferred) are in particular “batch” foaming and extrusion foaming.

According to embodiments, the foam thus formed consists essentially of, or even consists of, the copolymer described above (or the copolymers, if a mixture of copolymers is used) and optionally the blowing agent, if the latter remains present in the pores of the foam, notably if it is a foam with closed pores.

The foam produced according to the invention, in particular if it is a closed-pore foam, may contain a mixture of dinitrogen and carbon dioxide.

The foam produced according to the invention preferably has a density less than or equal to 0.8 g/cm³. Preferably, its density is from 0.05 to 0.8 g/cm³, more preferentially from 0.08 to 0.5 g/cm³, even more preferentially from 0.08 to 0.3 g/cm³. According to embodiments, the foam has a density of from 0.05 to 0.08 g/cm³, or from 0.08 to 0.1 g/cm³, or from 0.1 to 0.12 g/cm³, or from 0.12 to 0.15 g/cm³, or from 0.15 to 0.18 g/cm³, or from 0.18 to 0.2 g/cm³, or from 0.2 to 0.3 g/cm³, or from 0.3 to 0.4 g/cm³, or from 0.4 to 0.5 g/cm³, or from 0.5 to 0.6 g/cm³, or from 0.6 to 0.7 g/cm³, or from 0.7 to 0.8 g/cm³. The density may be controlled by adapting the parameters of the production process. The density can be measured according to the ISO standard 845: 2006.

Advantageously, the foam has an expansion rate ranging from 2 to 25, preferably from 3 to 20, more preferentially from 4 to 15. The expansion rate corresponds to the ratio of the volume of the foam to the volume of the polymer and is calculated in particular according to the formula:

Expansion rate=polymer density/foam density

Preferably, the foam has an expansion rate ranging from 2 to 3, or from 3 to 4, or from 4 to 5, or from 5 to 6, or from 6 to 7, or from 7 to 8, or from 8 to 9, or from 9 to 10, or from 10 to 11, or from 11 to 12, or from 12 to 13, or from 13 to 14, or from 14 to 15, or from 15 to 16, or from 16 to 17, or from 17 to 18, or from 18 to 19, or from 19 to 20, or from 20 to 21, or from 21 to 22, or from 22 to 23, or from 23 to 24, or from 24 to 25.

Particularly preferably, the foam is not crosslinked.

Preferably, this foam has a rebound resilience, according to the ISO standard 8307: 2007, of greater than or equal to 55%.

Preferably, this foam has a compression set, according to the ISO standard 7214: 2012, of less than or equal to 10% and more particularly preferably less than or equal to 8%.

Preferably, this foam also has excellent properties in terms of fatigue strength and dampening.

The foam according to the invention may be used for producing sports equipment, such as sports shoe soles, ski shoes, midsoles, insoles or functional sole components, in the form of inserts in the various parts of the sole (for example the heel or the arch), or shoe upper components in the form of reinforcements or inserts into the structure of the shoe upper, or in the form of protections.

It may also be used for producing inflatable balls, sports gloves (for example football gloves), golf ball components, rackets, protective elements (jackets, helmet interior elements, shells, etc.).

The foam according to the invention has advantageous anti-impact, anti-vibration and anti-noise properties, combined with haptic properties suitable for equipment goods. It may thus also be used for producing railway rail soles, or various parts in the motor vehicle industry, in transport, in electrical and electronic equipment, in construction or in the production industry.

One advantage of the foam objects according to the invention is that they can be readily recycled, for example by melting them in an extruder equipped with a degassing outlet (optionally after having chopped them into pieces).

### EXAMPLES

The examples that follow illustrate the invention without limiting it.

### Example 1

Two foams are prepared from a PEBA copolymer comprising blocks of PA 11 of number-average molar mass 600 g/mol and PTMG blocks of number-average molar mass 1000 g/mol.

The foams formed from the PEBA copolymer are produced using an Arburg Allrounder 270C injection press, with a system for injecting a physical blowing agent of Trexel series II type. The operating parameters are as follows:
Sheath temperature: from 50 to 230° C. (from the feed hopper to the injector nozzle); the temperature of the injected mixture may be likened to the sheath temperature at the injector nozzle;
Injection speed: 80 cm³/s;
Maintenance time before opening the mold: 30 s;
Maintenance pressure: 150 MPa;
Cooling time: 100 s;
Mold temperature: 60° C.;
Mold opening speed: 20 mm/s;
Mold thickness: 3 mm;
Mold opening distance: 12 mm.

The mold opening distance is defined as the maximum distance at which the mold can be opened while obtaining a good quality foam.

The blowing agent used is a mixture of 75% by weight of dinitrogen and 25% by weight of carbon dioxide, introduced in an amount of 1% by weight (foam No. 1) or 1.2% by weight (foam No. 2).

In addition, three comparative foams are prepared from the same copolymer and according to the same procedure, except that the blowing agent is either dinitrogen introduced in an amount of 0.6% by weight (foam No. 3) or 0.8% by weight (foam No. 4), or carbon dioxide introduced in an amount of 6-8% by weight (foam No. 5).

The density of the various foams is measured according to the ISO standard 845.

The expansion rate is defined as being the ratio of the volume of the foam to the volume of the polymer and is calculated in particular according to the formula:

Expansion rate=polymer density/foam density

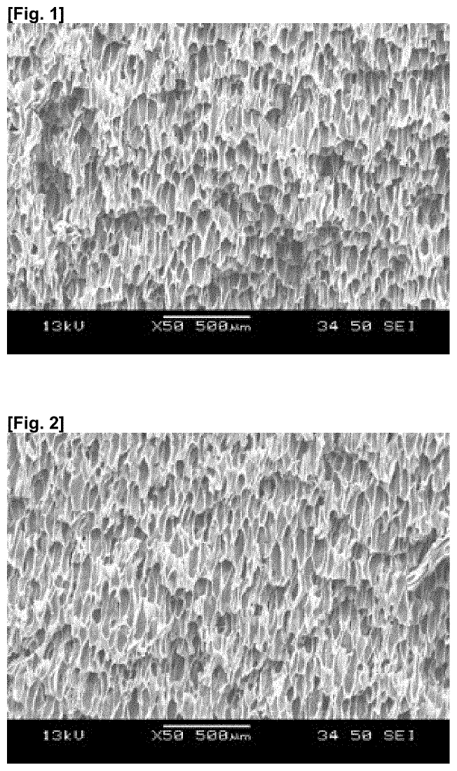

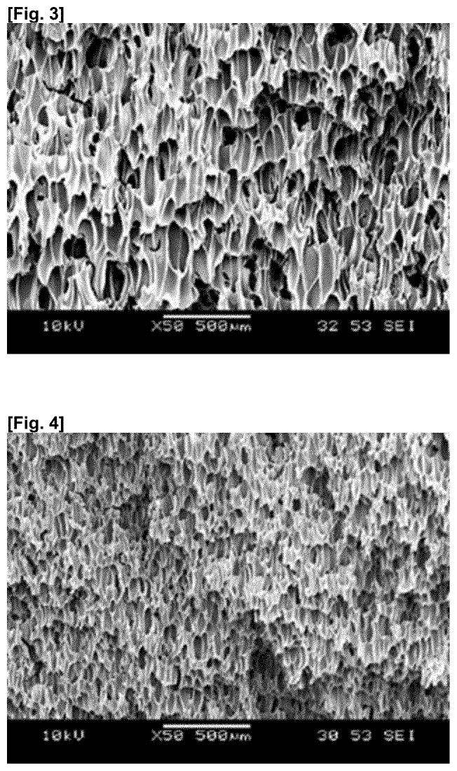

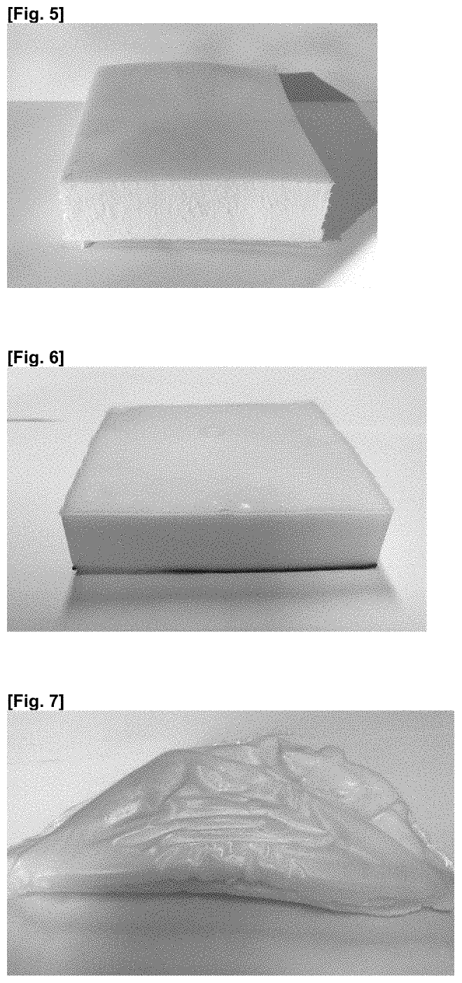

Images of the foams obtained are presented in FIGS. 1 to 7.

Foams No. 1 and 2 (produced according to the invention) have a density of approximately 0.14 g/cm³ and an expansion rate of 7.

Foams No. 3 and 4 (comparative examples) have a density of approximately 0.2 g/cm³ and an expansion rate of 5.

Foam No. 5 (comparative example) collapsed on itself.

The rebound resilience properties were measured according to the ISO standard 8307 (a 16.8 g steel ball 16 mm in diameter is dropped from a height of 500 mm onto a foam sample; the rebound resilience then corresponds to the percentage of energy returned to the ball, or percentage of the initial height reached by the ball on rebound).

The results are presented in the table below:

| Foam No. | 1 | 2 | 3 | 4 | 5 |
|---|---|---|---|---|---|
| Maximum | 7 | 7 | 5 | 5 | Not |
| expansion | | | | | measurable |
| rate | | | | | because |
| obtained | | | | | foam |
| | | | | | collapsed |
| Rebound | 59 | 60 | 61 | 61.5 | Not |
| resilience | | | | | measurable |
| (%) | | | | | because |
| | | | | | foam |
| | | | | | collapsed |

1. A process for producing a copolymer foam containing polyamide blocks and polyether blocks, comprising the following steps:
mixing the copolymer in the melt state with a blowing agent;
foaming of the mixture of copolymer and blowing agent;
wherein the blowing agent comprises a mixture of dinitrogen and carbon dioxide.

2. The process as claimed in claim 1, wherein the blowing agent comprises from 20% to 95% by weight of dinitrogen, and from 5% to 80% by weight of carbon dioxide.

3. The process as claimed in claim 1, wherein the polyamide blocks of the copolymer have a number-average molar mass of from 600 to 5000 g/mol.

4. The process as claimed in claim 1, wherein the polyether blocks of the copolymer have a number-average molar mass of from 250 to 2000 g/mol.

5. The process as claimed in claim 1, wherein the mass ratio of the polyamide blocks relative to the polyether blocks of the copolymer is from 0.3 to 10.

6. The process as claimed in claim 1, wherein the polyamide blocks of the copolymer are blocks of polyamide 6, of polyamide 11, of polyamide 12, of polyamide 5.4, of polyamide 5.9, of polyamide 5.10, of polyamide 5.12, of polyamide 5.13, of polyamide 5.14, of polyamide 5.16, of polyamide 5.18, of polyamide 5.36, of polyamide 6.4, of polyamide 6.9, of polyamide 6.10, of polyamide 6.12, of polyamide 6.13, of polyamide 6.14, of polyamide 6.16, of polyamide 6.18, of polyamide 6.36, of polyamide 10.4, of polyamide 10.9, of polyamide 10.10, of polyamide 10.12, of polyamide 10.13, of polyamide 10.14, of polyamide 10.16, of polyamide 10.18, of polyamide 10.36, of polyamide 10.T, of polyamide 12.4, of polyamide 12.9, of polyamide 12.10, of polyamide 12.12, of polyamide 12.13, of polyamide 12.14, of polyamide 12.16, of polyamide 12.18, of polyamide 12.36, of polyamide 12.T or mixtures thereof, or copolymers thereof.

7. The process as claimed in claim 1, wherein the polyether blocks are blocks of polyethylene glycol, of propylene glycol, of polytrimethylene glycol, of polytetrahydrofuran, or mixtures or copolymers thereof.

8. The process as claimed in claim 1, wherein the foam has a density less than or equal to 0.8 g/cm³.

9. The process as claimed in claim 1, wherein the foam is noncrosslinked.

10. The process as claimed in claim 1, comprising a step of injecting the mixture of copolymer and of blowing agent into a mold, the foaming of the mixture being carried out by opening the mold.

11. The process as claimed in claim 1, wherein the blowing agent is present in the mixture of copolymer and of blowing agent in a mass amount of from 0.1% to 10% relative to the sum of the weights of the blowing agent and of the copolymer containing polyamide blocks and polyether blocks.

12. The process as claimed in claim 1, comprising the mixing of the copolymer in the melt state with a blowing agent and with one or more additives.

13. The process as claimed in claim 1, which is an injection molding process.

14. A copolymer foam containing polyamide blocks and polyether blocks which can be obtained by a production process as claimed in claim 1.

15. The foam as claimed in claim 14, having a density less than or equal to 0.8 g/cm³.

16. The foam as claimed in claim 14, having an expansion rate ranging from 2 to 25.
